(19) United States
(12) Patent Application Publication
(10) Pub. No.: US 2013/0142249 A1
(43) Pub. Date: Jun. 6, 2013

(54) METHOD AND APPARATUS FOR PERFORMING VIDEO AND IMAGE COMPRESSION USING A VIDEO ENCODER

(71) Applicants: Pankaj Chaurasia, Cupertino, CA (US); Michael L. Schmit, Cupertino, CA (US)

(72) Inventors: Pankaj Chaurasia, Cupertino, CA (US); Michael L. Schmit, Cupertino, CA (US)

(73) Assignee: ADVANCED MICRO DEVICES, INC., Sunnyvale, CA (US)

(21) Appl. No.: 13/312,052

(22) Filed: Dec. 6, 2011

(51) Int. Cl. H04N 7/26

(52) U.S. Cl. 375/240.03; 375/E07.139

(57) ABSTRACT

A video encoding method and a video encoder are described for processing frames in a group of pictures (GOP). A difference between a bit budget of a selected frame in the GOP and an estimated number of bits consumed by the selected frame is determined. Quantization parameter (Qp) values assigned to coefficients of macroblocks (MBs) in the selected frame are adjusted if the difference does not fall within a tolerance. The Qp values may be filtered. A bit budget to the GOP may be assigned or adjusted based on a target bitrate. A bit budget may be assigned to each unprocessed frame in the GOP. Spatial activity may be calculated for each MB in the selected frame, and a bit budget and quantization may be assigned for each MB in the selected frame based on the spatial activity.

### FIELD OF INVENTION

The present invention is generally directed to the compression of frames in a group of pictures (GOP) using a video encoder.

### BACKGROUND

Video compression algorithms have historically been implemented in an encoder using software running on a processor or on dedicated hardware with a combination of firmware and hardware components.

An encoder may be a device, circuit, transducer, software program or algorithm that converts information (i.e., data) from one format or code to another. Encoding may be performed for the purposes of standardization, speed, secrecy, security, or saving memory space by reducing file size. A bitrate control mechanism of the encoder monitors the incremental file size being generated, compares it to the requested target bitrate, and makes adjustments on a small and large scale as necessary. This may generally be implemented by setting bit budgets and using various metrics within a frame to set the quantization level being used on a per macroblock (MB), slice or frame basis.

On processors and in firmware of hardware encoders, these changes may generally be made with a very short feedback time, since the processing is performed in a mostly serial fashion, one MB after another. For example, when beginning the quantization on one MB, the results of all of the previous MBs in a frame are generally known.

The goal of a bitrate control algorithm is to generate specific quantization levels (Qp) for each MB that provides a near uniform and optimum distortion level, (frame-to-frame and within a frame), that is within the dictated bit budget and keeps the video stream in compliance with buffer limits for overflow and underflow.

### SUMMARY OF EMBODIMENTS

A video encoding method and a video encoder are described for processing frames in a group of pictures (GOP). A difference between a bit budget of a selected frame in the GOP and an estimated number of bits consumed by the selected frame is determined. Quantization parameter (Qp) values assigned to coefficients of macroblocks (MBs) in the selected frame are adjusted if the difference does not fall within a tolerance. A bit budget to the GOP may be assigned or adjusted based on a target bitrate. A bit budget may be assigned to each unprocessed frame in the GOP. Spatial activity may be calculated for each MB in the selected frame, and a bit budget and quantization may be assigned for each MB in the selected frame based on the spatial activity. The number of bits consumed per MB in the selected frame may be approximated based on zero and non-zero coefficients of the MB. Quantization may be performed on each MB in the selected frame using the Qp values. The Qp values may be filtered.

A video encoder may comprise a memory configured to store at least one group of pictures (GOP), and a processor configured to determine a difference between a bit budget of a selected frame in the GOP and an estimated number of bits consumed by the selected frame, and adjust Qp values assigned to coefficients of MBs in the selected frame if the difference does not fall within a tolerance.

A computer-readable storage medium may be configured to store a set of instructions used for manufacturing a semiconductor device. The semiconductor device may comprise a memory configured to store at least one GOP, and a processor configured to determine a difference between a bit budget of a selected frame in the GOP and an estimated number of bits consumed by the selected frame, and adjust Qp values assigned to coefficients of MBs in the selected frame if the difference does not fall within a tolerance. The instructions may be Verilog data instructions or hardware description language (HDL) instructions.

### BRIEF DESCRIPTION OF THE DRAWINGS

A more detailed understanding may be had from the following description, given by way of example in conjunction with the accompanying drawings wherein:

FIG. 1 shows an example group of pictures (GOP) including a plurality of individual frames;

FIG. 2 shows an individual frame including a plurality of macroblocks (MBs);

FIGS. 3A, 3B and 3C, taken together, are a flow diagram of a video and image compression procedure;

FIG. 4 shows a block diagram of an example video encoder configured to perform the procedure of FIGS. 3A, 3B and 3C;

FIG. 5A is a block diagram of an example device in which one or more disclosed embodiments may be implemented; and

FIG. 5B is a block diagram of an alternate example device in which one or more disclosed embodiments may be implemented.

### DETAILED DESCRIPTION OF EMBODIMENTS

A processor, (e.g., a graphics processing unit (GPU), computer processing unit (CPU), and the like), may be configured to rapidly manipulate and alter memory in such a way so as to accelerate the building of images in a frame buffer intended for output to a display. Modern processors may be efficient at manipulating computer graphics, and their highly parallel structure makes them effective for implementing algorithms where processing of large blocks of data may be performed in parallel.

Compute shaders may be used to perform video compression while enhancing the speed of algorithms performed by the processor. A processor, (or an array of processors), may contain many compute engines such as compute shaders, (e.g., hundreds or thousands), and is thus termed as a massively parallel (MP) architecture.

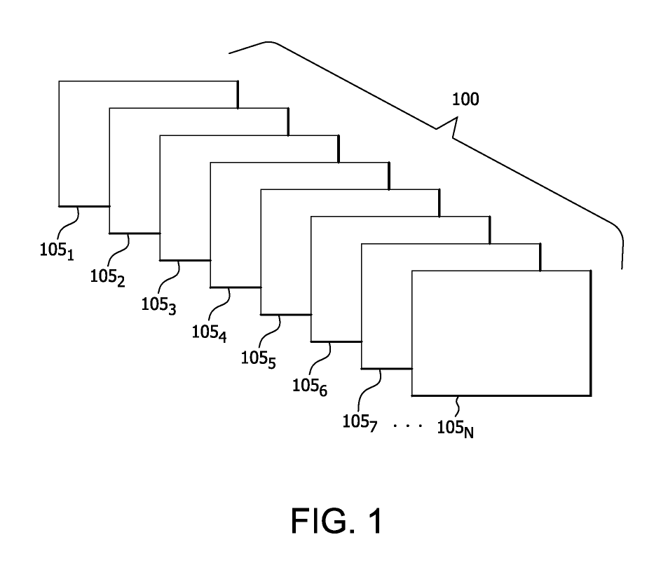

FIG. 1 shows an example group of pictures (GOP) 100 including a plurality of individual frames 105₁, 105₂, 105₃, 105₄, 105₅, 105₆, 105₇, . . . , 105_{N}, where N is the number of frames 105 in the GOP 100. Although N may be 255 or more in the GOP 100, N may be 15 for digital video disc (DVD) and Blu-ray disc (BD) applications, and N typically ranges from 30 to 60 for streaming and video conferencing applications.

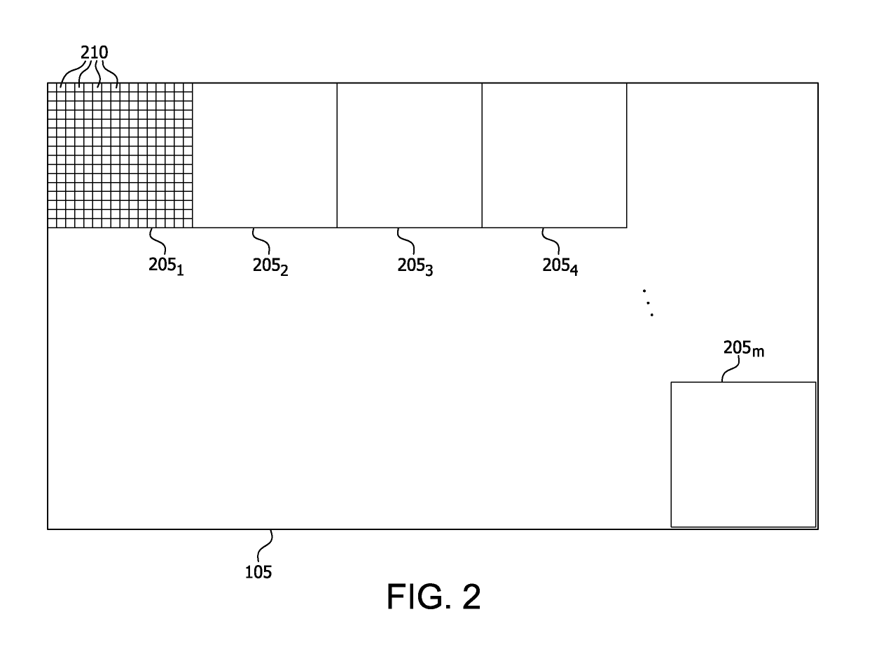

FIG. 2 shows an example individual frame 105 including a plurality of macroblocks (MBs) 205₁, 205₂, 205₃, 205₄, . . . , 205m, where m is the number of MBs in the frame 105. Each MB may include a plurality of pixels 210. In the example of FIG. 2, each MB 205 may include a 16×16 array of pixels 210. For example, the frame 105 may include a 120×68 matrix of MBs, (a total of 8160 MBs), that may support 1920×1080 video.

A data parallel programming model used in an MP machine may assign each processing unit to work on different data but with the same instructions. In video compression, for example, each 16×16 pixel MB may be processed at once so that adjacent MBs do not know the results of their neighboring MBs before they begin their processing.

In practice, a processing unit may not actually have that many processors, depending on the size of the video image and the capacity of the processing unit being used. However, the programming model allows one to assume one or more groups of MBs execute until all groups have completed. Every MB may begin processing at once and all may complete processing at the same time. Therefore, it may not be possible to adjust the processing of one MB based on the results of other MBs, as is done in conventional serial processing algorithms.

The primary problem is one of feedback on the quantity of bits being consumed from the first MB to the last (M^{th}) MB in the frame 105, as shown in FIG. 2. In serial algorithms, a quantization parameter (Qp) may be adjusted, MB by MB, in response to more difficult or less difficult portions of the image.

One solution to this problem is to divide the frame 105 into a plurality of slices, gather aggregate data in-between slices, and apply this feedback to the quantization levels used in future slices. This may work up to a point, but limits the total amount of parallelism. Another (not mutually exclusive) solution is to iteratively arrive at a final solution.

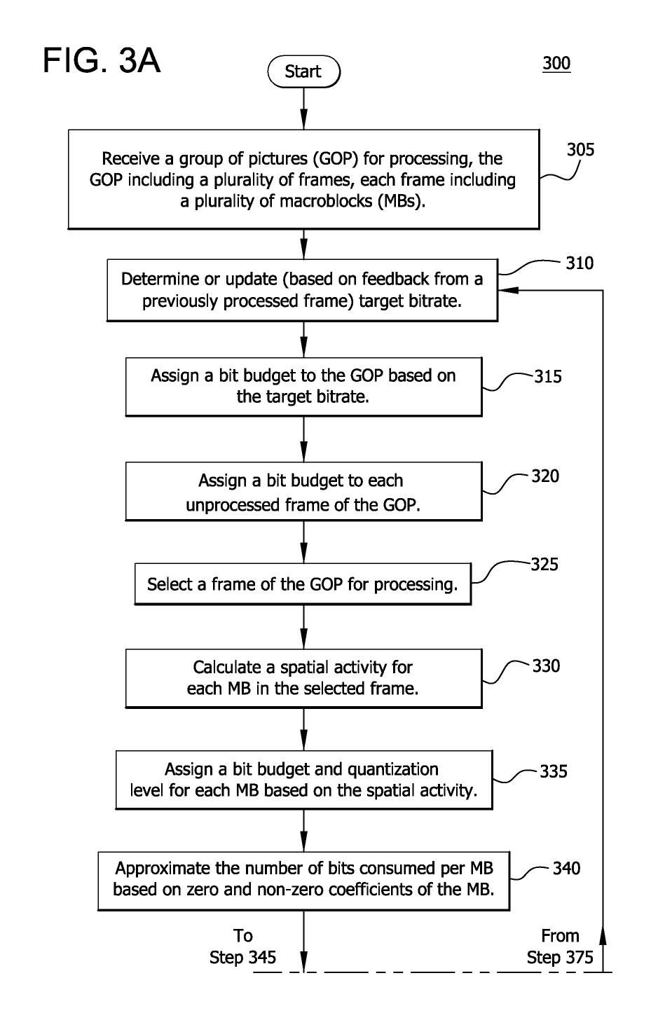

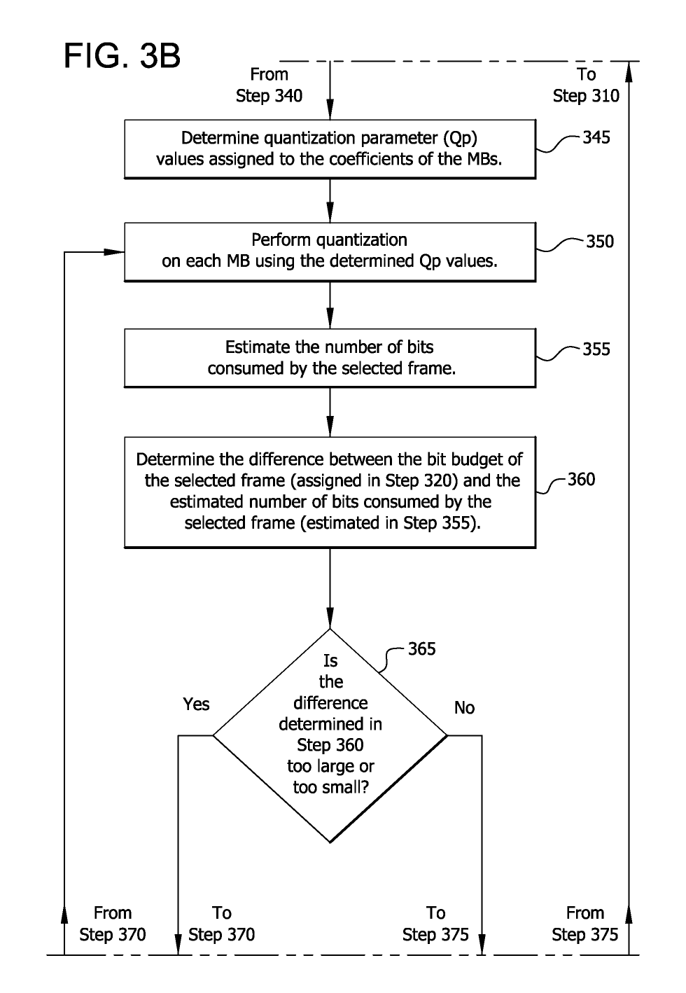

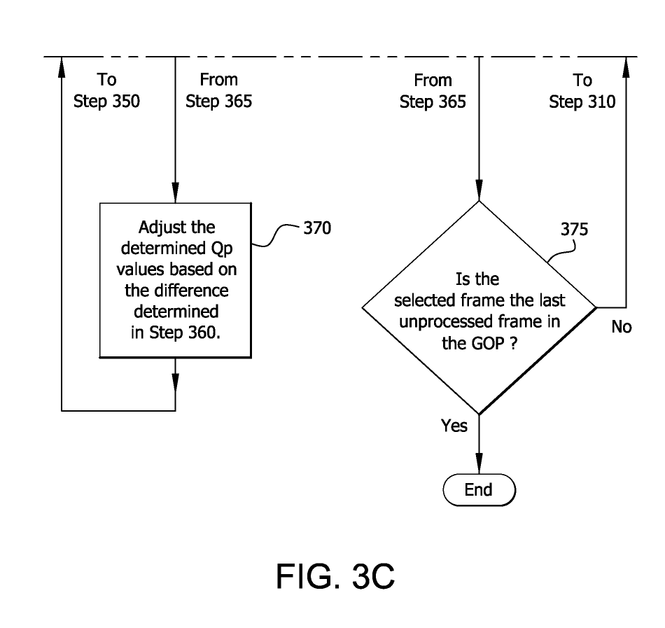

In accordance with one embodiment, the entire frame 105 may be processed using the video and image compression procedure 300 of FIGS. 3A, 3B and 3C. In the procedure 300, the entire frame may be processed with a tentative solution. A proxy to the real final encoding process may be calculated, the solution may be modified, and performed again and again until the result is refined within an acceptable tolerance, or until no improvement is being made in each iteration.

Entropy encoding is the final procedure of the overall encoding process, whereby all of the encoding decisions are converted and the actual bits that go into the stream are encoded. This procedure provides the actual numbers of bits. Prior to doing this final procedure, various estimates may be used to reduce the number of bits required. The tentative solution may use one Qp value and estimate how many bits may be consumed. If it is close to the allocated number of bits, then final entropy processing may be implemented. If the estimate falls outside of the expected range, then Qp may be adjusted and the estimate may be performed again, perhaps iterating several times.

As shown in FIG. 3A, a group of pictures (GOP) is received for processing in an encoder (305). The GOP may include a plurality of frames. Each frame may include a plurality of MBs. A target bitrate is determined, or is updated, (based on feedback from a previously processed frame of the GOP), (310). A bit budget is assigned to the GOP based on the target bitrate (315). A bit budget is assigned to each unprocessed frame of the GOP (320). An unprocessed frame (i.e., a frame that has not yet gone through steps 330-375 of the procedure 300) in the GOP is selected (325). A spatial activity is calculated for each MB in the selected frame (330). A bit budget and quantization level is assigned for each MB (335). The number of bits consumed is approximated per MB based on zero and non-zero coefficients of the MB based on the spatial activity (340).

As shown in FIG. 3B, quantization parameter (Qp) values assigned to the coefficients of the MBs are determined (345). Quantization is performed on each MB using the determined Qp values (350). The number of bits consumed by the selected frame is estimated (355). A determination 360 is made as to the difference between the bit budget of the selected frame (assigned in 320) and the estimated number of bits consumed by the selected frame (estimated in 355). A determination 365 is made as to whether the difference determined in 360 is too large or too small.

As shown in FIGS. 3B and 3C, if the determination 365 is positive, the determined Qp values are adjusted (370) based on the difference determined in 360 and the procedure 300 returns to 350. If the determination 365 is negative, and it is determined (375) that there is at least one more frame in the GOP to process, (i.e., the selected frame is not the last unprocessed frame in the GOP), the procedure 300 returns to 310.

After the array of per MB Qp levels has been generated (in the iterative stages above), a filter may be optionally run on the Qp values to minimize the changes in Qp, thus attempting to maintain a constant or lesser distortion as the same or fewer bits are consumed. This may be accomplished by taking into account the bit cost in the stream for making a change to the Qp versus the benefit of making the change.

When the frame has completed the entropy encoding stage, the final true sum of bits consumed is tallied and compared to the budget for that frame. This feedback may be used to make two adjustments on future frames. First, the bit budget model may be adjusted, if required. Second, the overall video sequence buffer model is adjusted to insure that the bits of the frames are maintained within the required limits.

Since the processing of frames may have a deep pipeline, the feedback, (per frame and per GOP) may not be immediate, and thus the iterative per frame bit budget allocation and closeness to this budget are important. However, video scenes may be suddenly different and a method is needed for allocating some reserved number of additional bits. If there is a sudden change, such as a cut to a new scene, there may be a need for more bits because the motion estimation from prior frames may produce poor results. Thus, detection of a new scene may be used as a trigger to allow using some reserve bits.

An enhancement may provide a budget for each frame in two parts, (e.g., 90% may be free to be completely used, and the remainder (10%) may only be used after the first iteration of the quantization, if needed). Any of these reserved bits that are not used may then be carried over to the next frame in the pipeline.

The accumulation over time of these reserved or standby bits needs to be great enough to handle (approximately) the expected worst case condition that may occur every one in 50 or 100 frames, that is suddenly more difficult than expected, whereas the normally budgeted allocation may always be used within a GOP.

Each iteration of the proxy quantization may be implemented based on a reduced resolution image, or based on a statistical sampling of the MBs, thus reducing the computation time. After the quantization is determined to be final, the full resolution image may be quantized. The size of the reduced (i.e., compressed) resolution image may be optimized.

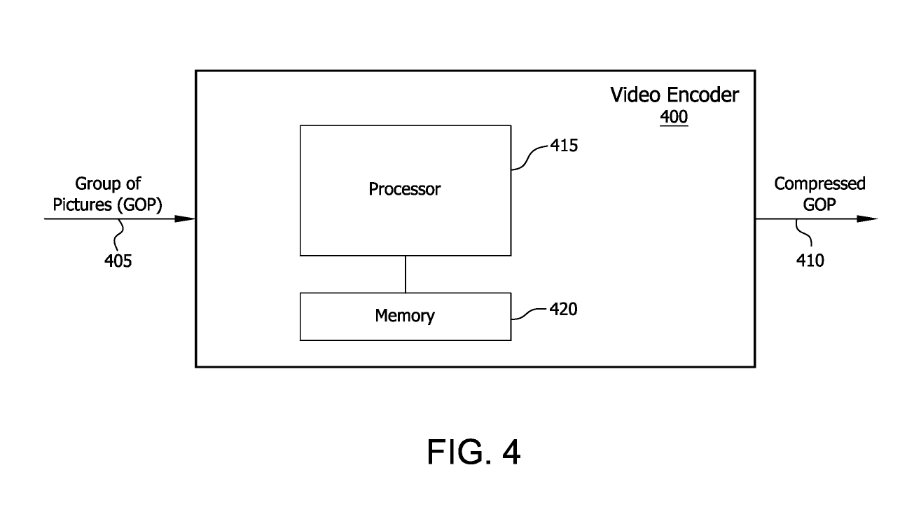

FIG. 4 shows a block diagram of an example video encoder 400 configured to perform the procedure of FIGS. 3A, 3B and 3C. The video encoder 400 is configured to receive at least one GOP, process the GOP and output a compressed GOP 410. The video encoder may include a processor 415 and a memory 420. The memory 420 may be configured to store at least one GOP. The processor 415 may be configured to determine a difference between a bit budget of a selected frame in the GOP and an estimated number of bits consumed by the selected frame, and adjust Qp values assigned to coefficients of MBs in the selected frame if the difference does not fall within a tolerance. The processor 415 may further be configured to assign or update a bit budget to the GOP based on a target bitrate, assign a bit budget to each unprocessed frame in the GOP, calculate a spatial activity for each MB in the selected frame, assign a bit budget and quantization for each MB in the selected frame based on the spatial activity, approximate the number of bits consumed per MB in the selected frame based on zero and non-zero coefficients of the MB, perform quantization on each MB in the selected frame using the Qp values, and filter the Qp values. The encoded output may then be stored on a fixed or removable storage device or used for other processing.

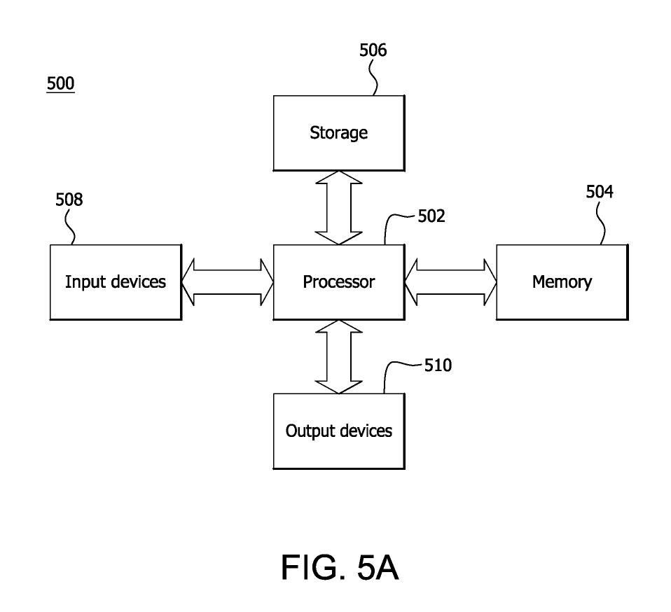

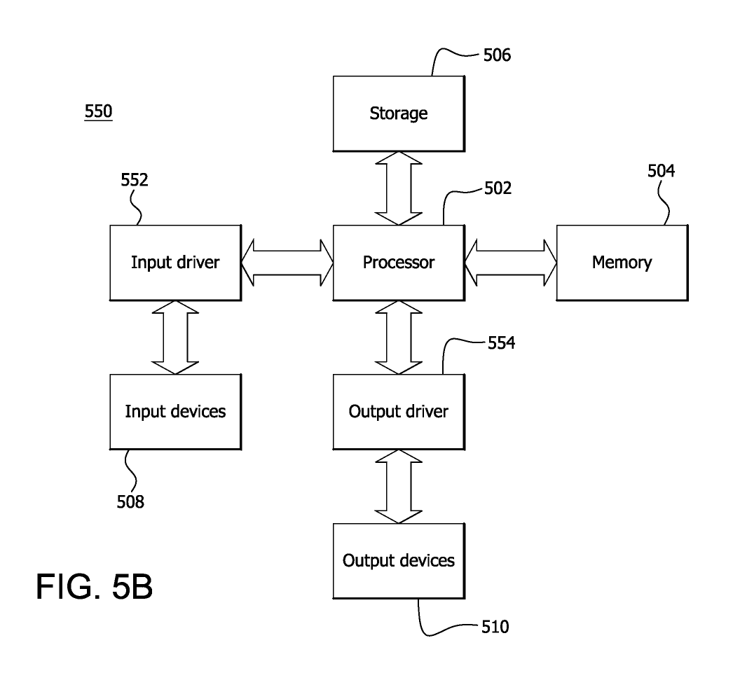

FIG. 5A is a block diagram of an example device 500 configured to perform the procedure 300 of FIG. 3 and/or the functions of the video encoder 400 of FIG. 4. The device 500 may include, for example, a computer, a gaming device, a handheld device, a set-top box, a television, a mobile phone, or a tablet computer. The device 500 includes a processor 502, a memory 504, a storage 506, one or more input devices 508, and one or more output devices 510. It is understood that the device 500 may include additional components not shown in FIG. 5A.

The processor 502 may include a CPU, a GPU, a CPU and GPU located on the same die, one or more processor cores, wherein each processor core may be a CPU or a GPU. The memory 504 may be located on the same die as the processor 502, or may be located separately from the processor 504. The memory 504 may include a volatile or non-volatile memory, for example, random access memory (RAM), dynamic RAM, or a cache.

The storage 506 may include a fixed or removable storage, for example, hard disk drive, solid state drive, optical disk, or flash drive. The input devices 508 may include a keyboard, a keypad, a touch screen, a touch pad, a detector, a microphone, an accelerometer, a gyroscope, a biometric scanner, or a network connection, (e.g., a wireless local area network card for transmission and/or reception of wireless IEEE 802 signals). The output devices 510 may include a display, a speaker, a printer, a haptic feedback device, one or more lights, an antenna, or a network connection, (e.g., a wireless local area network card for transmission and/or reception of wireless IEEE 802 signals).

FIG. 5B is a block diagram of an alternate example device 550 in which one or more disclosed embodiments may be implemented. Elements of the device 550 which are the same as in the device 500 are given like reference numbers. In addition to the processor 502, the memory 504, the storage 506, the input devices 508, and the output devices 510, the device 550 also includes an input driver 552 and an output driver 554.

The input driver 552 communicates with the processor 502 and the input devices 508, and permits the processor 502 to receive input from the input devices 508. The output driver 554 communicates with the processor 502 and the output devices 510, and permits the processor 502 to send output to the output devices 510.

Although features and elements are described above in particular combinations, each feature or element can be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), an accelerated processing unit (APU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A video encoding method of processing frames in a group of pictures (GOP), the method comprising:
determining a difference between a bit budget of a selected frame in the GOP and an estimated number of bits consumed by the selected frame; and
adjusting quantization parameter (Qp) values assigned to coefficients of macroblocks (MBs) in the selected frame if the difference does not fall within a tolerance.

2. The method of claim 1 further comprising:
assigning or updating a bit budget to the GOP based on a target bitrate.

3. The method of claim 2 further comprising:
assigning a bit budget to each unprocessed frame in the GOP.

4. The method of claim 3 further comprising:
calculating a spatial activity for each MB in the selected frame.

5. The method of claim 4 further comprising:
assigning a bit budget and quantization for each MB in the selected frame based on the spatial activity.

6. The method of claim 5 further comprising:
approximating the number of bits consumed per MB in the selected frame based on the coefficients of the MB.

7. The method of claim 6 wherein the coefficients include zero and non-zero coefficients.

8. The method of claim 6 further comprising:
performing quantization on each MB in the selected frame using the Qp values.

9. The method of claim 1 further comprising:
filtering the Qp values.

10. A video encoder comprising:
a memory configured to store at least one group of pictures (GOP); and
a processor configured to determine a difference between a bit budget of a selected frame in the GOP and an estimated number of bits consumed by the selected frame, and adjust quantization parameter (Qp) values assigned to coefficients of macroblocks (MBs) in the selected frame if the difference does not fall within a tolerance.

11. The video encoder of claim 10 wherein the processor is further configured to assign or update a bit budget to the GOP based on a target bitrate.

12. The video encoder of claim 11 wherein the processor is further configured to assign a bit budget to each unprocessed frame in the GOP.

13. The video encoder of claim 12 wherein the processor is further configured to calculate a spatial activity for each MB in the selected frame.

14. The video encoder of claim 13 wherein the processor is further configured to assign a bit budget and quantization for each MB in the selected frame based on the spatial activity.

15. The video encoder of claim 14 wherein the processor is further configured to approximate the number of bits consumed per MB in the selected frame based on zero and non-zero coefficients of the MB.

16. The video encoder of claim 15 wherein the processor is further configured to perform quantization on each MB in the selected frame using the Qp values.

17. The video encoder of claim 15 wherein the processor is further configured to filter the Qp values.

18. A computer-readable storage medium configured to store a set of instructions used for manufacturing a semiconductor device, wherein the semiconductor device comprises:
a memory configured to store at least one group of pictures (GOP); and
a processor configured to determine a difference between a bit budget of a selected frame in the GOP and an estimated number of bits consumed by the selected frame, and adjust quantization parameter (Qp) values assigned to coefficients of macroblocks (MBs) in the selected frame if the difference does not fall within a tolerance.

19. The computer-readable storage medium of claim 18 wherein the instructions are Verilog data instructions.

20. The computer-readable storage medium of claim 18 wherein the instructions are hardware description language (HDL) instructions.

21. A computer-readable storage medium configured to store video data encoded by determining a difference between a bit budget of a selected frame in a group of pictures and an estimated number of bits consumed by the selected frame, and adjusting quantization parameter values assigned to coefficients of macroblocks in the selected frame if the difference does not fall within a tolerance.
